(19) United States
(12) Patent Application Publication
(10) Pub. No.: US 2018/0284520 A1
(43) Pub. Date: Oct. 4, 2018

(54) SUBSTRATE, PREPARING METHOD THEREOF, AND LIQUID CRYSTAL DISPLAY SCREEN

(71) Applicants: BOE Technology Group Co., Ltd., Beijing (CN); Hefei Xinsheng Optoelectronics Technology Co., Ltd, Hefei (CN)

(72) Inventors: Huan Ni, Beijing (CN); Xinxia Zhang, Beijing (CN)

(73) Assignees: BOE TECHNOLOGY GROUP CO., LTD.; HEFEI Xinsheng Optoelectronics Technology Co., Ltd

(21) Appl. No.: 15/838,525

(22) Filed: Dec. 12, 2017

(30) Foreign Application Priority Data
Mar. 31, 2017 (CN) 201710210188.6

(51) Int. Cl. G02F 1/1347; G02F 1/1343; G02F 1/1362

(52) U.S. Cl. CPC G02F 1/13471; G02F 2001/133368; G02F 1/136209; G02F 1/13439

(57) ABSTRACT

The present disclosure provides a substrate, applied to a liquid crystal display screen. The substrate includes: a base and an over coat layer disposed in a laminated mode, and further comprises at least one transparent film layer. The at least one transparent film layer is disposed on a surface of the substrate facing a liquid crystal layer or a surface of the substrate back to the liquid crystal layer. The at least one transparent film layer comprises a first film layer and a second film layer disposed in a laminated mode. The refractive index of the first film layer is higher than that of the second film layer. The present disclosure further provides a method for preparing a substrate and a liquid crystal display screen.

The present application claims priority to Chinese Patent Application No.: 201710210188.6, filed with the State Intellectual Property Office on Mar. 31, 2017 and titled “Substrate, Preparing Method thereof and Liquid Crystal Display Screen”, which is incorporated herein by reference in its entirety.

### TECHNICAL FIELD

The present disclosure relates to the field of liquid crystal display technology, and particularly to a substrate, a preparing method thereof, and a liquid crystal display screen.

### BACKGROUND

Shortwave blue light is the light rays with wavelengths between 400 nm-480 nm and having relatively higher energy. Blue light within such a wavelength range will increase macular toxins in eyes, and severely threaten our fundus oculi health. Since shortwave light rays have relatively higher energy, the scattering rate is relatively high when they meet tiny particles in air, which is the main cause of dazzling. Visible light rays have different focal points after they are focused in the eyes, and a focal point distance difference forms between two focal points, which is the main cause of blurred vision. Long time visual fatigue will cause other fatigue symptoms. Incidence of blue light will aggravate the focal point distance difference and the blurred vision degree since the focal point falls between the retina and the crystalline lens instead of falling on the retina after the blue light is focused, and thus the focal point distance difference of the light rays focused in the eyes increases. Therefore, how to effectively remove the blue light of a liquid crystal display screen is an urgent problem to be solved.

### SUMMARY

The present disclosure provides a substrate for a liquid crystal display screen. The substrate includes: a base and an over coat layer disposed in a laminated mode, and further includes: at least one transparent film layer. The at least one transparent film layer is disposed on a surface of the substrate facing a liquid crystal layer or a surface of the substrate facing away from the liquid crystal layer, and the at least one transparent film layer includes a first film layer and a second film layer disposed in a laminated mode. The refractive index of the first film layer is higher than that of the second film layer.

In some embodiments, the at least one transparent film layer serves as a shield electrode of the substrate when the substrate is for the liquid crystal display screen in a planar electric field display mode. Alternatively, the at least one transparent film layer serves as a common electrode of the substrate when the substrate is for the liquid crystal display screen in a vertical electric field display mode.

In some embodiments, the refractive index of the first film layer is 1.85˜2.85; and/or the refractive index of the second film layer is 1.1˜1.9.

In some embodiments, the thickness of the first film layer is 200˜300 μm; and/or the thickness of the second film layer is 200˜300 μm.

In some embodiments, the material of the first film layer is ITO, TiO₂, ZnO or SnO₂, and the material of the second film layer is ITO or SiO₂.

In some embodiments, the material of the first film layer is ITO, and the material of the second film layer is SiO₂. Alternatively, the material of the first film layer is TiO₂, and the material of the second film layer is ITO.

In some embodiments, when the substrate is for the liquid crystal display screen in a planar electric field display mode, the at least one transparent film layer is disposed on a first surface of the base and the first surface of the base is a surface facing away from the liquid crystal layer. Alternatively, when the substrate is for the liquid crystal display screen in a vertical electric field display mode, the at least one transparent film layer is disposed on a first surface of the over coat layer and the first surface of the over coat layer is a surface facing the liquid crystal layer.

In some embodiments, the at least one transparent film layer has at least one via hole. Each of the at least one via hole is over against an opaque region of a display area of the substrate, and a conductive medium is disposed in each of the at least one via hole.

In some embodiments, an ITO layer is disposed on a first surface of an outermost transparent film layer. The first surface of the outermost transparent film layer is a surface furthest away from the liquid crystal layer.

The present disclosure further provides a liquid crystal display screen. The liquid crystal display screen includes: a substrate, wherein the substrate includes a base and an over coat layer disposed in a laminated mode, and the substrate includes at least one transparent film layer. The at least one transparent film layer is disposed on a surface of the substrate facing a liquid crystal layer or a surface of the substrate facing away from the liquid crystal layer, and the at least one transparent film layer includes a first film layer and a second film layer disposed in a laminated mode. The refractive index of the first film layer is higher than that of the second film layer.

In some embodiments, the at least one transparent film layer serves as a shield electrode of the substrate when the substrate is for the liquid crystal display screen in a planar electric field display mode. Alternatively, the at least one transparent film layer serves as a common electrode of the substrate when the substrate is for the liquid crystal display screen in a vertical electric field display mode.

In some embodiments, the refractive index of the first film layer is 1.85˜2.85; and/or the refractive index of the second film layer is 1.1˜1.9.

In some embodiments, when the substrate is for the liquid crystal display screen in a planar electric field display mode, the at least one transparent film layer is disposed on a first surface of the base and the first surface of the base is a surface facing away from the liquid crystal layer. Alternatively, when the substrate is for the liquid crystal display screen in a vertical electric field display mode, the at least one transparent film layer is disposed on a first surface of the over coat layer and the first surface of the over coat layer is a surface facing the liquid crystal layer.

In some embodiments, the at least one transparent film layer has at least one via hole. Each of the at least one via hole is over against an opaque region of a display area of the substrate, and a conductive medium is disposed in each of the at least one via hole.

In some embodiments, an ITO layer is disposed on a first surface of an outermost transparent film layer. The first surface of the outermost transparent film layer is a surface furthest away from the liquid crystal layer.

The present disclosure further provides a method for preparing a substrate. The substrate is for a liquid crystal display screen, and the method includes: forming an over coat layer on a base; and forming at least one transparent film layer on a surface of the substrate facing a liquid crystal layer or a surface of the substrate facing away from the liquid crystal layer. The at least one transparent film layer includes a first film layer and a second film layer disposed in a laminated mode. The refractive index of the first film layer is higher than that of the second film layer.

In some embodiments, the at least one transparent film layer serves as a shield electrode of the substrate when the substrate is for the liquid crystal display screen in a planar electric field display mode. Alternatively, the at least one transparent film layer serves as a common electrode of the substrate when the substrate is for the liquid crystal display screen in a vertical electric field display mode.

In some embodiments, when the substrate is for the liquid crystal display screen in the planar electric field display mode, the step of forming the at least one transparent film layer on the surface of the substrate facing away from the liquid crystal layer includes: forming the at least one transparent film layer on a first surface of the base. The first surface of the base is a surface facing away from the liquid crystal layer. Alternatively, when the substrate is for the liquid crystal display screen in the vertical electric field display mode, the step of forming the at least one transparent film layer on the surface of the substrate facing the liquid crystal layer includes: forming the at least one transparent film layer on a first surface of the over coat layer. The first surface of the over coat layer is a surface facing the liquid crystal layer.

In some embodiments, after the step of forming the at least one transparent film layer on the surface of the substrate facing the liquid crystal layer or the surface of the substrate facing away from the liquid crystal layer, the method further includes: forming at least one via hole in the transparent film layer. The at least one via hole is over against an opaque region of a display area of the substrate; and disposing a conductive medium in each of the at least one via hole.

In some embodiments, after the step of disposing the conductive medium in each of the at least one via hole, the method further includes: forming an ITO layer on a first surface of an outermost transparent film layer. The first surface of the outermost transparent film layer is a surface furthest away from the liquid crystal layer.

### BRIEF DESCRIPTION OF THE DRAWINGS

To describe the technical solutions in the embodiments of the present disclosure more clearly, the following briefly introduces the accompanying drawings that illustrate aspects of the various embodiments. The accompanying drawings in the following description show some embodiments of the present disclosure, and a person of ordinary skill in the art may derive other drawings from these accompanying drawings.

FIG. 1 is a structural schematic diagram of a substrate in an embodiment of the present disclosure;

FIG. 2 is a structural schematic diagram of a substrate in an embodiment of the present disclosure;

FIG. 3 is a flow chart of a method for preparing a substrate in an embodiment of the present disclosure;

FIG. 4 is a flow chart of a method for preparing a substrate in an embodiment of the present disclosure.

### DETAILED DESCRIPTION

Technical solutions of the present disclosure will be described in a detailed and comprehensive manner with reference to the accompanying drawings in the embodiments of the present disclosure. The described embodiments shown merely some instead all of the embodiments of the present disclosure. Based on the embodiments of the present disclosure, all other embodiments derived by those of ordinary skill in the art without any creative work shall be within the protection scope of the present disclosure.

A liquid crystal display screen consists of two substrates and a liquid crystal layer disposed between the two substrates. For example, the two substrates may be a color filter substrate and an array substrate respectively. The liquid crystal display screen is manufactured by assembling the two substrates into a cell and adding a liquid crystal therebetween. The liquid crystal is an organic compound which is between a solid state and a liquid state and has a regular molecular arrangement as well as crystal optical anisotropy. The liquid crystal presents a transparent liquid state when it's heated to a certain temperature, and presents a turbid solid state of crystalline particles when it's cooled. The liquid crystal in the liquid crystal display screen emits no light, but controls the passing amount of external light rays. When external light rays pass through the liquid crystal molecules, the twisted state of the liquid crystal molecule arrangement is different, such that the passing amount of the light rays is different, thereby realizing brightness changes and image reproduction. The twisted size of the liquid crystal molecules is decided by the difference between voltages applied to two sides of the liquid crystal molecules, thereby realizing the conversion from electricity to light. That is, the passing amount of the light rays is controlled by high and low voltages, to convert electric signals into light images. In the present disclosure, a transparent film layer with alternate high and low refractive indexes is formed on a substrate, such that blue light can be cut off when the light rays pass through the substrate.

On such a basis, the embodiments of the present disclosure disclose a substrate. The substrate is for a liquid crystal display screen. The liquid crystal display screen has a plurality of display modes, such as a planar electric field display mode, a vertical electric field display mode, etc. The difference between the planar electric field display mode and the vertical electric field display mode lies in different electric fields applied to the liquid crystal molecules. The direction of the electric field as applied in the planar electric field display mode is horizontal and the liquid crystal molecules take a torsional movement in parallel with the substrate. While, the direction of the electric field as applied in the vertical electric field display mode is vertical to the substrate. Here, the substrate in the present disclosure is further explained by taking the planar electric field display mode and the vertical electric field display mode as examples.

The embodiments of the present disclosure provide a substrate, and the substrate may be for the liquid crystal display screen in the planar electric field display mode. The planar electric field display mode may be a display mode of advanced super dimension switch (ADS), in-plane switching (IPS), fringe field switching (FFS) or high aperture advanced super dimensional switching (HADS), or the like.

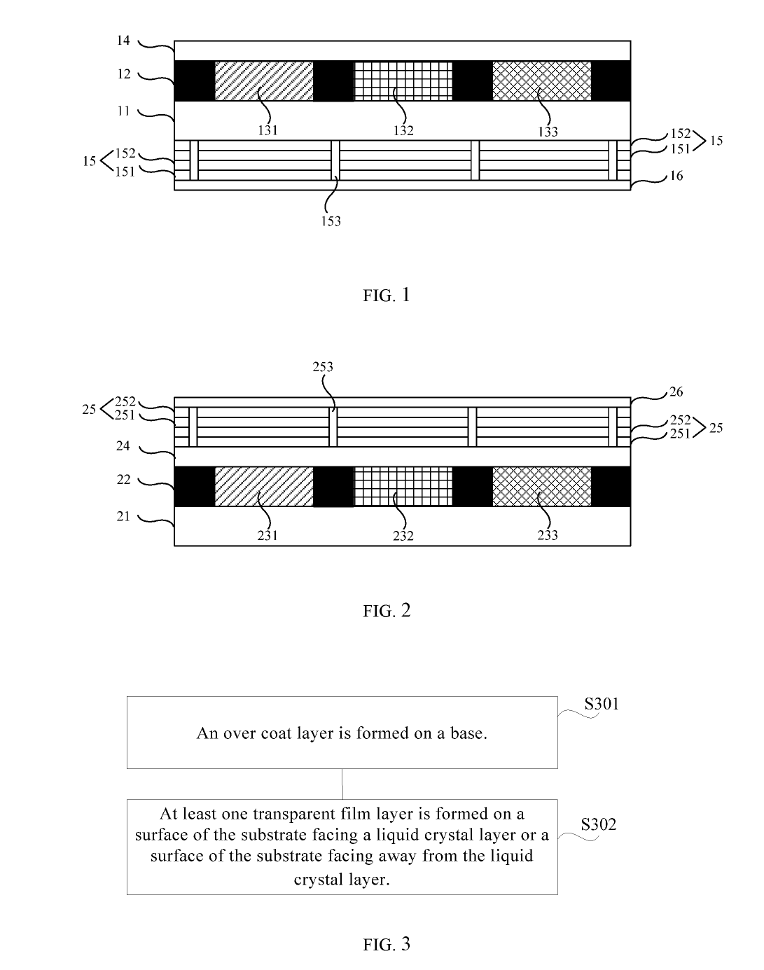

As shown in FIG. 1, the substrate includes a base (Glass) 11, an over coat (OC) layer 14 and at least one transparent film layer 15. The at least one transparent film layer 15 is disposed on the surface of the substrate facing away from the liquid crystal layer. The at least one transparent film layer 15 includes: a first film layer 151 and a second film layer 152 arranged in a laminated mode. The refractive index of the first film layer 151 is higher than that of the second film layer 152, such that the at least one transparent film layer 15 forms a layer structure with alternate high and low refractive indexes, which can precisely cut off high-energy blue light so as to reduce the harm to user's eyes. The present disclosure does not limit the laminating sequence of the first film layer 151 and the second film layer 152. The layer number of the transparent film layer is not limited. Generally speaking, the more the layer number of the transparent film layer 15 is, the better the light filtering effect is, but the higher the cost is. Therefore, the layer number may be selected in accordance with specific requirements.

In addition, since the substrate is for the liquid crystal display screen in the planar electric field display mode, the at least one transparent film layer 15 may be used as a shield electrode of the substrate, to realize an electrostatic shielding function and to prevent the noise caused by static electricity. Thus, the preparing flow for the liquid crystal display screen in the planar electric field display mode can be effectively simplified.

In some embodiments, the base 11 may be a glass base. The base 11 includes a first surface and a second substrate which are disposed oppositely. The first surface of the base 11 is a surface facing away from the liquid crystal layer. The at least one transparent film layer 15 is disposed on the first surface of the base 11. The over coat layer 14 includes a first surface and a second surface which are disposed oppositely. The first surface of the over coat layer 14 is a surface facing the liquid crystal layer.

In accordance with different functions of the substrate, the substrate may be provided with other structures. For example, as shown in FIG. 1, the substrate further includes a black matrix (BM) 12 and color filters (CF). The black matrix 12 and the color filters are located between the second surface of the base 11 and the second surface of the over coat layer 14. The black matrix layer 12 plays a lightproof role. The color filters include red filters 131, green filters 132 and blue filters 133 which are disposed in sequence. The color filters can play a role of generating rich colors. The over coat layer 14 plays a role of protecting the black matrix 12 and the color filters.

In some embodiments, the refractive index of the material of the first film layer 151 may be 1.85˜2.85, and the refractive index of the material of the second film layer 152 may be 1.1˜1.9. In some embodiments, the material of the first film layer 151 is ITO, TiO₂, ZnO or SnO₂, and the material of the second film layer 152 is ITO or SiO₂.

For the above materials, the refractive index of the ITO film is affected by the preparing process, the chemical ratio and the thickness of the ITO film. For example, 1) when the evaporation rate for preparing the ITO film is improved, the refractive index of the ITO film increases; 2) the refractive index of the ITO film decreases with the increase of oxygen flow; 3) the refractive index of the ITO film increases with the increase of the annealing temperature; and 4) the refractive index of the ITO film decreases with the increase of its thickness. Therefore, the ITO film of a corresponding refractive index may be obtained by adjusting the corresponding parameters, such that the ITO film can serve as a high-refractive index material and a low-refractive index material.

The refractive index of TiO₂ is n=2.3˜2.5 and TiO₂ is a high-refractive index material. The TiO₂ films of different refractive indexes may be obtained by adjusting the process parameters, the film layer thickness and the doped elements.

The refractive index of ZnO is 2.008˜2.029 and ZnO is a high-refractive index material.

The refractive index of SnO₂ is 1.9968 and SnO₂ is a high-refractive index material.

The refractive index of SiO₂ is 1.46˜1.48 and SiO₂ is a low-refractive index material.

In some embodiments, the material of the first film layer 151 is ITO, and the material of the second film layer 152 is SiO₂. Here, ITO is used as a high-refractive index material. Since both ITO and SiO₂ are easy to process, the transparent film layer 15 of such specific materials is easy to realize in process and good in machinability.

In some embodiments, the material of the first film layer 151 may be TiO₂, and the material of the second film layer 152 may be ITO. Here, ITO is used as a low-refractive index material. As the electric conductivity of TiO₂ is relatively high, the resistivity of the transparent film layer 15 is relatively low, such that the transparent film layer 15 is favorable for the electrostatic shielding effect when it's used as a shield electrode.

In some embodiments, the thickness of the first film layer 151 may be 200˜300 μm. The thickness of the second film layer 152 may be 200˜300 μm. The first film layer 151 and the second film layer 152 of such thicknesses can guarantee the blue light filtering effect, and meanwhile the thickness of the substrate will not increase obviously. When the substrate is for the liquid crystal display screen, the display effect of the liquid crystal display screen will not be affected.

An insulating material, for example SiO₂, may be used in the at least one transparent film layer 15. In order to realize the electric connection of the at least one transparent film layer 15, the at least one transparent film layer 15 may have at least one via hole 153. Each of the at least one via hole 153 is over against an opaque region of a display area of the substrate. For example, as shown in FIG. 1, for the substrate with the black matrix 12, the via hole 153 is over against the black matrix 12. A conductive medium is disposed in each via hole 153. When the at least one transparent film layer 15 includes a plurality of transparent film layers, every layer in the transparent film layer 15 is electrically connected and the plurality of transparent film layers 15 are electrically connected by the conductive medium, to reduce the resistivity of the transparent film layer 15. The size of the via hole 153 may be adjusted based on needs, and the size of the via hole has a negative correlation with the resistivity of the transparent film layer. The larger the via hole 153 is, the smaller the resistivity is.

In some embodiments, an ITO layer 16 is disposed on a first surface of the outermost transparent film layer 15. The first surface of the outermost transparent film layer 15 is a surface furthest away from the liquid crystal layer. ITO material is an N-type semiconductor material. After Sn is doped into In₂O₃, Sn may exist in the form of SnO₂ by replacing In element in In₂O₃ lattices. Since In element in In₂O₃ is plus trivalent, one electron is provided for the conduction band when SnO₂ is formed, and meanwhile oxygen vacancies are generated under a certain anaerobic condition. This mechanism provides a low film resistivity with an order of magnitude of 10⁻⁴(Ω*cm), and therefore the ITO material has the electric conductivity of semiconductors. Therefore, it is favorable to electrically connect the at least one transparent film layer 15 to other structures by disposing the ITO layer 16.

In conclusion, the substrate provided in the embodiments of the present disclosure is applicable to the liquid crystal display screen in the planar electric field display mode. Since the transparent film layer 15 is formed by adopting the high-refractive index first film layer 151 and the low-refractive index second film layer 152, the transparent film layer 15 becomes a long wave transparent film, which can accurately cut off high-energy blue light so as to reduce the harm to user's eyes. In addition, the transparent film layer 15 can be used as a shield electrode of the substrate to realize an electrostatic shielding function and to prevent the noise caused by static electricity. Thus, the preparing flow for the liquid crystal display screen in the planar electric field display mode can be effectively simplified. Besides, by forming the via hole 153 coated with the conductive medium, the electric conductivity of the transparent film layer 15 may be further improved, such that the first film layer 151 and the second film layer 152 in the transparent film layer 15 can be electrically connected and the plurality of transparent film layers 15 are electrically connected. By disposing the ITO layer 16, the transparent film layer 15 can be electrically connected to other structures.

The embodiments of the present disclosure provide another substrate. The substrate may be for the liquid crystal display screen in a vertical electric field display mode. The vertical electric field display mode can be a twisted nematic (TN) display mode, a super twisted nematic (STN) display mode or the like.

As shown in FIG. 2, the substrate includes a base 21, an over coat layer 24 and at least one transparent film layer 25. The at least one transparent film layer 25 is disposed on a surface of the substrate facing a liquid crystal layer. Same as the substrate shown in FIG. 1, the at least one transparent film layer 25 includes a first film layer 251 and a second film layer 252 arranged in a laminated mode. The refractive index of the first film layer 251 is higher than that of the second film layer 252, such that the at least one transparent film layer 25 forms a layer structure with alternate high and low refractive indexes. The present disclosure does not limit the laminating sequence of the first film layer 251 and the second film layer 252. The layer number of the transparent film layer 25 is not limited. Generally speaking, the more the layer number of the transparent film layer 25 is, the better the light filtering effect is, but the higher the cost is. Therefore, the layer number may be selected based on specific requirements.

In addition, when the substrate is for the liquid crystal display screen in the vertical electric field display mode, since the common electrode in the liquid crystal display screen is disposed on the surface of the substrate facing the liquid crystal layer, the at least one transparent film layer 25 may be used as the common electrode of the substrate to provide a common electric signal. In this way, the substrate does not need to be additionally provided with a common electrode, thereby effectively simplifying the preparing flow for the liquid crystal display screen in the vertical electric field display mode.

In some embodiments, the base 21 may be a glass base. The base 21 includes a first surface and a second surface which are disposed oppositely. The first surface of the base 21 is a surface facing away from the liquid crystal layer. The over coat layer 24 includes a first surface and a second surface which are disposed oppositely. The first surface of the over coat layer 24 is a surface facing the liquid crystal layer. The at least one transparent film layer 25 is disposed on the first surface of the over coat layer 24.

In accordance with different functions of the substrate, the substrate may be provided with other structures. For example, as shown in FIG. 2, the substrate further includes a black matrix 22 and color filters. The black matrix 22 and the color filters are located between the second surface of the base 21 and the second surface of the over coat layer 24. The black matrix layer 22 plays a lightproof role. The color filters include red filters 231, green filters 232 and blue filters 233 which are disposed in sequence. The color filters may play a role of generating rich colors. The over coat layer 24 plays a role of protecting the black matrix 22 and the color filters.

In some embodiments, the refractive index of the material of the first film layer 251 may be 1.85˜2.85, and the refractive index of the material of the second film layer 252 may be 1.1˜1.9. In some embodiments, the material of the first film layer 251 is ITO, TiO₂, ZnO or SnO₂, and the material of the second film layer 252 is ITO or SiO₂.

The refractive indexes of the above materials can be referenced to those of the corresponding materials in the substrate for the liquid crystal display screen in the planar electric field display mode, and are not repeated here.

In some embodiments, the material of the first film layer 251 is ITO, and the material of the second film layer 252 is SiO₂. Here, ITO is used as a high-refractive index material. Since both ITO and SiO₂ are easy to process, the transparent film layer 25 of such specific materials is easy to realize in process and good in machinability.

In some embodiments, the material of the first film layer 251 may be TiO₂, and the material of the second film layer 252 may be ITO. Here, ITO is used as a low-refractive index material. Since the electric conductivity of TiO₂ is relatively high, the resistivity of the transparent film layer 25 is relatively low, such that the transparent film layer 25 is favorable for the display effect when it's used as a transparent common electrode.

In some embodiments, the thickness of the first film layer 251 may be 200˜300 μm. The thickness of the second film layer 252 may be 200˜300 μm. The first film layer 251 and the second film layer 252 of such thicknesses can guarantee the blue light filtering effect, and meanwhile the thickness of the substrate will not increase obviously. When the substrate is for the liquid crystal display screen, the display effect of the liquid crystal display screen will not be affected.

An insulating material, for example SiO₂, may be used in the at least one transparent film layer 25. In order to realize the electric connection of the at least one transparent film layer 25, the at least one transparent film layer 25 may have at least one via hole 253. Each of the at least one via hole 253 is over against an opaque region of a display area of the substrate. For example, as shown in FIG. 2, for the substrate with the black matrix 22, the via hole 253 is over against the black matrix 22. A conductive medium is disposed in each via hole 253. When the at least one transparent film layer 25 includes a plurality of transparent film layers, every layer in the transparent film layer 25 is electrically connected and the plurality of transparent film layers 25 are electrically connected by the conductive medium, so as to reduce the resistivity of the transparent film layer 25. The size of the via hole 253 may be adjusted based on needs, and the size of the via hole has a negative correlation with the resistivity of the transparent film layer. The larger the via hole 253 is, the smaller the resistivity is.

In some embodiments, an ITO layer 26 is disposed on a first surface of the outermost transparent film layer 25. The first surface of the outermost transparent film layer 25 is a surface furthest away from the liquid crystal layer. Since the ITO material has electric conductivity, it is favorable to electrically connect the at least one transparent film layer 25 to other structures by disposing the ITO layer 26.

In conclusion, the substrate provided by the embodiments of the present disclosure is used in the liquid crystal display screen in the vertical electric field display mode. Since the transparent film layer 25 is formed by adopting the high-refractive index first film layer 251 and the low-refractive index second film layer 252, the transparent film layer 25 becomes a long wave transparent film, which can accurately cut off high-energy blue light to reduce the harm to user's eyes. In addition, the transparent film layer 25 may be used as a common electrode of the substrate to provide a common electric signal. Thus, the preparing flow for the liquid crystal display screen in the vertical electric field display mode can be effectively simplified. Besides, by forming the via hole 253 coated with the conductive medium, the electric conductivity of the transparent film layer 25 can be further improved, such that the first film layer 251 and the second film layer 252 in the transparent film layer 25 are electrically connected and the plurality of transparent film layers 25 are electrically connected. The transparent film layer 25 can be electrically connected to other structures by disposing the ITO layer 26.

The embodiments of the present disclosure further provide a method for preparing a substrate. The method may be used for preparing the substrate as shown in FIG. 1 or FIG. 2. As shown in FIG. 3, the method includes the following steps:

Step S301: an over coat layer is formed on a base.

Specifically, the over coat layer may be manufactured on the base in a coating manner.

In accordance with different functions of the substrate, other structures may be manufactured on the base. For example, a black matrix and color filters may be manufactured on the base, such that the substrate may become a color filter substrate.

Specifically, the black matrix is manufactured on the base first. Then R, G and B photoresistors are coated sequentially in the clearances of the black matrix, and the color filters are obtained through exposure, developing and baking. The obtained color filters are red filters, green filters and blue filters. R photoresistors are red photoresistors, G photoresistors are green photoresistors and B photoresistors are blue photoresistors.

S302: at least one transparent film layer is formed on a surface of the substrate facing a liquid crystal layer or a surface of the substrate facing away from the liquid crystal layer.

When the substrate for the liquid crystal display screen in the planar electric field display mode as shown in FIG. 1 is prepared, the at least one transparent film layer is formed on the surface facing away from the liquid crystal layer at step S302. Specifically, step S302 is implemented in the following manner.

At least one transparent film layer is formed on a first surface of the base.

The first surface of the base is a surface facing away from the liquid crystal layer.

When the substrate for the liquid crystal display screen in the vertical electric field display mode as shown in FIG. 2 is prepared, the at least one transparent film layer is formed on the surface facing the liquid crystal layer at step S302. Specifically, step S302 is implemented in the following manner.

At least one transparent film layer is formed on a first surface of the over coat layer.

The first surface of the over coat layer is a surface facing the liquid crystal layer.

The layer number of the transparent film layer is not limited. Generally speaking, the more the layer number of the transparent film layer is, the better the light filtering effect is, but the higher the cost is. Therefore, the layer number may be selected based on specific requirements.

The transparent film layer includes a first film layer and a second film layer arranged in a laminated mode, and the refractive index of the first film layer is higher than that of the second film layer.

In some embodiments, the first film layer and the second film layer are evaporated on the surface of the substrate facing or facing away from the liquid crystal layer in sequence to obtain the transparent film layer. The present disclosure does not limit the sequence of evaporating the first film layer and the second film layer. If there are more than two transparent film layers, the first film layer and the second film layer are continuously evaporated in this sequence.

In some embodiments, when the substrate is for the liquid crystal display screen in the planar electric field display mode, the at least one transparent film layer may be used as a shield electrode of the substrate, to realize the electrostatic shielding function and to prevent the noise caused by static electricity. Thus, the preparing flow for the liquid crystal display screen in the planar electric field display mode can be effectively simplified.

In some embodiments, when the substrate is for the liquid crystal display screen in the vertical electric field display mode, the at least one transparent film layer may be used as a common electrode of the substrate to provide a common electric signal. Thus, the preparing flow for the liquid crystal display screen in the vertical electric field display mode can be effectively simplified.

In some embodiments, the refractive index of the material of the first film layer may be 1.85˜2.85, and the refractive index of the material of the second film layer may be 1.1˜1.9. In some embodiments, the material of the first film layer is ITO, TiO₂, ZnO or SnO₂, and the material of the second film layer is ITO or SiO₂.

In some embodiments, the material of the first film layer is ITO, and the material of the second film layer is SiO₂. Since both ITO and SiO₂ are easy to process, the transparent film layer of such specific materials is easy to realize in process and good in machinability.

In some embodiments, the material of the first film layer is TiO₂, and the material of the second film layer is ITO. Since the electric conductivity of TiO₂ is relatively high, the resistivity of the transparent film layer is relatively low, such that the transparent film layer is favorable for the electrostatic shielding effect when it's used as a shield electrode, and is favorable for the display effect when used as a transparent common electrode.

In some embodiments, the thickness of the first film layer may be 200˜300 μm. The thickness of the second film layer may be 200˜300 μm. The first film layer and the second film layer of such thicknesses can guarantee the blue light filtering effect, and meanwhile the thickness of the substrate will not increase obviously. When the substrate is for the liquid crystal display screen, the display effect of the liquid crystal display screen will not be affected.

In conclusion, the method for preparing a substrate provided in the embodiments of the present disclosure is applicable for preparing the substrate for the liquid crystal display screen in the planar electric field display mode or the vertical electric field display mode. By preparing the high-refractive index first film layer and the low-refractive index second film layer into the transparent film layer, the transparent film layer becomes a long wave transparent film, which can precisely cut off high-energy blue light to reduce the harm to user's eyes. Besides, when the substrate is for the liquid crystal display screen in the planar electric field display mode, the transparent film layer may be used as a shield electrode of the substrate to realize the electrostatic shielding function and to prevent the noise caused by static electricity. Thus, the preparing flow for the liquid crystal display screen in the planar electric field display mode may be effectively simplified. When the substrate is for the liquid crystal display screen in the vertical electric field display mode, the transparent film layer may be used as a common electrode of the substrate to provide a common electric signal, thereby effectively simplifying the preparing flow for the liquid crystal display screen in the vertical electric field display mode.

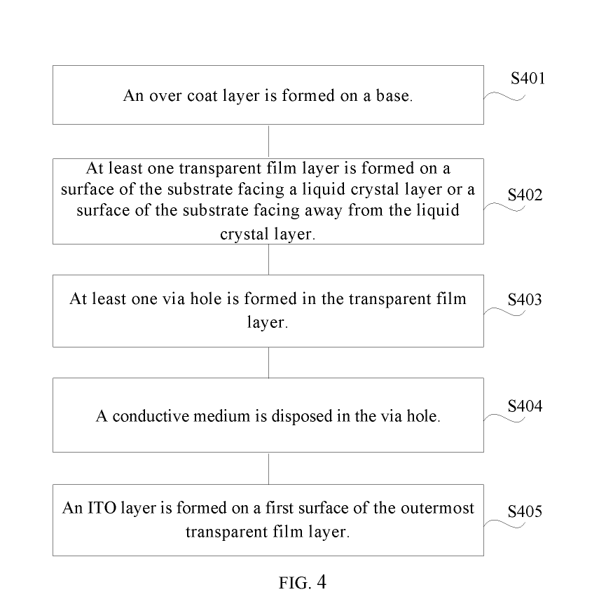

The embodiments of the present disclosure further provide a method for preparing a substrate. The method may be used for preparing the substrate as shown in FIG. 1 or FIG. 2. As shown in FIG. 4, the method includes the following steps:

Step S401: an over coat layer is formed on a base.

Step S402: at least one transparent film layer is formed on a surface of the substrate facing a liquid crystal layer or a surface of the substrate facing away from the liquid crystal layer.

The above steps S401˜S402 are same as steps S301-S302 as shown in FIG. 3, and are not repeated here.

Step S403: at least one via hole is formed in the transparent film layer.

At least one via hole is formed in the at least one transparent film layer.

Each of the at least one via hole is over against an opaque region of a display area of the substrate.

Exemplarily, the surface of the transparent film layer where the via hole need to be provided is subjected to photoresist coating, exposure and developing to obtain the via hole.

Step S404: a conductive medium is disposed in the via hole.

The conductive medium is disposed in each of the at least one via hole.

Exemplarily, the conductive medium may be disposed in the via hole in a manner of coating.

Step S405: an ITO layer is formed on a first surface of the outermost transparent film layer.

When the substrate for the liquid crystal display screen in the planar electric field display mode as shown in FIG. 1 is prepared, the first surface of the outermost transparent film layer is a surface furthest away from the liquid crystal layer. When the substrate for the liquid crystal display screen in the vertical electric field display mode as shown in FIG. 2 is prepared, the first surface of the outermost transparent film layer is also the surface furthest away from the liquid crystal layer.

In conclusion, the method for preparing a substrate provided by the embodiments of the present disclosure is applicable for preparing the substrate for the liquid crystal display screen in the planar electric field display mode or the vertical electric field display mode. By preparing the high-refractive index first film layer and the low-refractive index second film layer into the transparent film layer, the transparent film layer becomes a long wave transparent film, which can precisely cut off high-energy blue light to reduce the harm to user's eyes. Besides, when the substrate is for the liquid crystal display screen in the planar electric field display mode, the transparent film layer may be used as a shield electrode of the substrate to realize the electrostatic shielding function and to prevent the noise caused by static electricity. Thus, the preparing flow for the liquid crystal display screen in the planar electric field display mode can be effectively simplified. When the substrate is for the liquid crystal display screen in the vertical electric field display mode, the transparent film layer may be used as a common electrode of the substrate to provide a common electric signal. Thus, the preparing flow for the liquid crystal display screen in the vertical electric field display mode can be effectively simplified. In addition, by manufacturing the via hole coated with the conductive medium, the electric conductivity of the transparent film layer can be further improved, such that the first film layer and the second film layer in the transparent film layer may be electrically connected, and the plurality of transparent film layers may be electrically connected. By manufacturing the ITO layer, the transparent film layer can be electrically connected to other structures.

The embodiments of the present disclosure further provide a liquid crystal display screen. The liquid crystal display screen includes two substrates disposed oppositely, and a liquid crystal layer disposed between the two substrates. The substrate may adopt the substrate for the liquid crystal display screen in the planar electric field display mode as shown in FIG. 1 or the substrate for the liquid crystal display screen in the vertical electric field display mode as shown in FIG. 2. For example, the two substrates may be a color filter substrate and an array substrate respectively.

The liquid crystal display screen provided by the present disclosure may be applied to various display devices, such as mobile phones, tablet computers, televisions, displays, laptops, digital photo frames, navigators, and any other products or parts with display function.

In conclusion, for the liquid crystal display screen provided in the embodiments of the present disclosure, since the high-refractive index first film layer and the low-refractive index second film layer are adopted to form the transparent film layer, the transparent film layer becomes a long wave transparent film, which can precisely cut off high-energy blue light to reduce the harm to user's eyes. When the substrate is for the liquid crystal display screen in the planar electric field display mode, the transparent film layer may be used as a shield electrode of the substrate to realize the electrostatic shielding function and to prevent the noise caused by static electricity. Thus, the preparing flow for the liquid crystal display screen in the planar electric field display mode may be effectively simplified. When the substrate is for the liquid crystal display screen in the vertical electric field display mode, the transparent film layer may be used as a common electrode of the substrate to provide a common electric signal. Thus, the preparing flow for the liquid crystal display screen in the vertical electric field display mode can be effectively simplified.

The embodiments in the present specification are described progressively, and each embodiment emphatically explains the difference from other embodiments. The same or similar parts among the embodiments are mutually referable.

Although alternative embodiments of the present disclosure have been described, those skilled in the art may make other alterations and modifications to these embodiments once having a knowledge of the basic creative concept. Therefore, the appended claims are intended to comprise the alternative embodiments, all alterations and modifications falling within the scope of the embodiments of the present disclosure.

Finally, it should be explained that in this text, the relation terms such as first and second are merely intended to differentiate one entity or operation from another entity or operation rather than necessarily requiring or implying any actual relation or sequence among these entities or operations. Besides, the terms “comprise”, “contain” or any other variants are intended to cover non-exclusively containing, such that the process, method, article or terminal device comprising a series of key elements not only comprises those key elements but also comprises other inexplicitly listed key elements, or further comprises inherent key elements of such process, method, article or terminal device. In a case of no more limitations, the key elements defined in the sentence “comprise a” do not exclude additional same key elements in the process, method, article or terminal device comprising the key elements.

The foregoing are merely specific embodiments of the present disclosure and the scope of protection of the present disclosure is not limited hereto. Within the technical scope of the present disclosure, any modifications or substitutions that may readily derived by a person of ordinary skill in the art shall be within the scope of protection of the present disclosure. Therefore, the scope of protection of the present disclosure shall be defined by the claims.

What is claimed:

1. A substrate for a liquid crystal display screen, comprising: a base and an over coat layer disposed in a laminated mode, and further comprising: at least one transparent film layer; wherein the at least one transparent film layer is disposed on a surface of the substrate facing a liquid crystal layer or a surface of the substrate facing away from the liquid crystal layer; and the at least one transparent film layer comprises a first film layer and a second film layer disposed in a laminated mode, wherein a refractive index of the first film layer is higher than that of the second film layer.

2. The substrate of claim 1, wherein the at least one transparent film layer serves as a shield electrode of the substrate when the substrate is for the liquid crystal display screen in a planar electric field display mode; or
the at least one transparent film layer serves as a common electrode of the substrate when the substrate is for the liquid crystal display screen in a vertical electric field display mode.

3. The substrate of claim 1, wherein the refractive index of the first film layer is 1.85˜2.85; and/or the refractive index of the second film layer is 1.1˜1.9.

4. The substrate of claim 1, wherein a thickness of the first film layer is 200˜300 μm; and/or a thickness of the second film layer is 200˜300 μm.

5. The substrate of claim 1, wherein a material of the first film layer is ITO, TiO₂, ZnO or SnO₂, and a material of the second film layer is ITO or SiO₂.

6. The substrate of claim 5, wherein the material of the first film layer is ITO, and the material of the second film layer is SiO₂; or
the material of the first film layer is TiO₂, and the material of the second film layer is ITO.

7. The substrate of claim 1, wherein when the substrate is used in the liquid crystal display screen in a planar electric field display mode, the at least one transparent film layer is disposed on a first surface of the base and the first surface of the base is a surface facing away from the liquid crystal layer; or
when the substrate is used in the liquid crystal display screen in a vertical electric field display mode, the at least one transparent film layer is disposed on a first surface of the over coat layer and the first surface of the over coat layer is a surface facing the liquid crystal layer.

8. The substrate of claim 1, wherein the at least one transparent film layer has at least one via hole, each of the at least one via hole is over against an opaque region of a display area of the substrate, and a conductive medium is disposed in each of the at least one via hole.

9. The substrate of claim 6, wherein an ITO layer is disposed on a first surface of an outermost transparent film layer, wherein
the first surface of the outermost transparent film layer is a surface furthest away from the liquid crystal layer.

10. A liquid crystal display screen, comprising a substrate,
wherein the substrate comprises a base and an over coat layer disposed in a laminated mode and further comprises at least one transparent film layer; the at least one transparent film layer is disposed on a surface of the substrate facing a liquid crystal layer or a surface of the substrate facing away from the liquid crystal layer; and the at least one transparent film layer comprises a first film layer and a second film layer disposed in a laminated mode, wherein a refractive index of the first film layer is higher than that of the second film layer.

11. The liquid crystal display screen of claim 10, wherein the at least one transparent film layer serves as a shield electrode of the substrate when the substrate is used in the liquid crystal display screen in a planar electric field display mode; or
the at least one transparent film layer serves as a common electrode of the substrate when the substrate is used in the liquid crystal display screen in a vertical electric field display mode.

12. The liquid crystal display screen of claim 10, wherein the refractive index of the first film layer is 1.85˜2.85; and/or the refractive index of the second film layer is 1.1˜1.9.

13. The liquid crystal display screen of claim 10, wherein when the substrate is used in the liquid crystal display screen in a planar electric field display mode, the at least one transparent film layer is disposed on a first surface of the base and the first surface of the base is a surface facing away from the liquid crystal layer; or
when the substrate is used in the liquid crystal display screen in a vertical electric field display mode, the at least one transparent film layer is disposed on a first surface of the over coat layer and the first surface of the over coat layer is a surface facing the liquid crystal layer.

14. The liquid crystal display screen of claim 10, wherein the at least one transparent film layer has at least one via hole, each of the at least one via hole is over against an opaque region of a display area of the substrate, and a conductive medium is disposed in each of the at least one via hole.

15. The liquid crystal display screen of claim 10, wherein an ITO layer is disposed on a first surface of an outermost transparent film layer, wherein
the first surface of the outermost transparent film layer is a surface furthest away from the liquid crystal layer.

16. A method for preparing a substrate, wherein the substrate is for a liquid crystal display screen, and the method comprises:
forming an over coat layer on a base; and
forming at least one transparent film layer on a surface of the substrate facing a liquid crystal layer or a surface of the substrate facing away from the liquid crystal layer;
wherein the at least one transparent film layer comprises a first film layer and a second film layer disposed in a laminated mode, and a refractive index of the first film layer is higher than that of the second film layer.

17. The method of claim 16, wherein the at least one transparent film layer serves as a shield electrode of the substrate when the substrate is for the liquid crystal display screen in a planar electric field display mode; or
the at least one transparent film layer serves as a common electrode of the substrate when the substrate is for the liquid crystal display screen in a vertical electric field display mode.

18. The method of claim 16, wherein, when the substrate is used in the liquid crystal display screen in a planar electric field display mode, the step of forming the at least one transparent film layer on the surface of the substrate facing away from the liquid crystal layer comprises:
forming the at least one transparent film layer on a first surface of the base, wherein the first surface of the base is a surface facing away from the liquid crystal layer; or
when the substrate is for the liquid crystal display screen in a vertical electric field display mode, the step of forming the at least one transparent film layer on the surface of the substrate facing the liquid crystal layer comprises:
forming the at least one transparent film layer on a first surface of the over coat layer, wherein the first surface of the over coat layer is a surface facing the liquid crystal layer.

19. The method of claim 16, after the step of forming the at least one transparent film layer on the surface of the substrate facing the liquid crystal layer or the surface of the substrate facing away from the liquid crystal layer, further comprising:
forming at least one via hole in the at least one transparent film layer, wherein each of the at least one via hole is over against an opaque region of a display area of the substrate; and
disposing a conductive medium in each of the at least one via hole.

20. The method of claim 19, after the step of disposing the conductive medium in each of the at least one via hole, further comprising:
forming an ITO layer on a first surface of an outermost transparent film layer,
wherein the first surface of the outermost transparent film layer is a surface furthest away from the liquid crystal layer.
